(19) United States
(12) Patent Application Publication
(10) Pub. No.: US 2014/0365315 A1
(43) Pub. Date: Dec. 11, 2014

(54) SYSTEMS AND METHODS FOR CUSTOMIZING SERVICES TO USERS ON MOBILE TECHNOLOGY PLATFORMS USING PERSONAS

(71) Applicant: Cellrox, Ltd., Tel Aviv (IL)

(72) Inventors: Oren LAADAN, New-York, NY (US); Omer Yehiel EIFERMAN, Tel-Aviv (IL); Ranit R. FINK-ISAACS, Bit Arif (IL); Amir GOLDSTEIN, Tel-Aviv (IL)

(73) Assignee: CELLROX, LTD., Tel Aviv (IL)

(21) Appl. No.: 14/470,066

(22) Filed: Aug. 27, 2014

Related U.S. Application Data
(63) Continuation of application No. PCT/IL2013/050151, filed on Feb. 20, 2013.
(60) Provisional application No. 61/604,483, filed on Feb. 28, 2012.

(51) Int. Cl. H04L 29/08; G06Q 30/02; H04L 12/58

(52) U.S. Cl. CPC H04L 67/306; H04L 51/04; G06Q 30/0269
USPC 705/14.66; 709/203

(57) ABSTRACT

A method and system are provided for customizing a service to a user on a mobile technology platform. The method include determining which of a plurality of personas defined in the mobile technology platform is an active persona, wherein each persona of the plurality of personas is defined as a set of user preferences associated with an operating system of the mobile technology platform; and customizing a service to the user based on the active persona.

### CROSS-REFERENCE TO RELATED APPLICATIONS

This application is a continuation application of international application No. PCT/IL2013/050151, filed on Feb. 20, 2013, which claims the benefit of U.S. provisional application No. 61/604,483, filed on Feb. 28, 2012, the contents of which are incorporated herein by reference.

### TECHNICAL FIELD

The present disclosure relates generally to mobile technology platforms, and more particularly to systems and methods for customizing services provided to a user based on an active persona or an association of the user's online behavior with a particular persona.

### BACKGROUND

Mobile technology platforms, including mobile communications and mobile computing devices, are used in various settings for various types of tasks. Frequently, it is desirable for the user of such a device to adopt various roles or “personas” while using the device. For example, the user may be utilizing the device for both personal and business use, and hence has the need to switch between these personas.

In light of the foregoing, some systems have been developed to allow the user to switch between personas. For example, U.S. Pat. No. 7,086,008 (hereinafter “Capps et al.”) discloses computer systems which may adopt one of many personas, depending upon the role that its owner is currently undertaking. The computer system includes a central repository of extensible personas available to all applications running on the computer system. Each such persona has associated therewith a suite of parameters, or specific values for parameters, which are appropriate for conducting transactions in the name of their respective personas.

The computer system of Capps et al. further provides a graphical user interface which allows the user to switch from persona to persona by simply selecting a particular persona from a list of available personas displayed on a display screen of the computer system. By selecting a persona, the user causes the computer system to globally change the entire suite of parameter values so that subsequent transactions conducted with the computer system employ the parameter values of the current persona.

In preferred embodiments of the system of Capps et al., the suite of parameters representing a given persona can be extended by applications running on the computer system. Specifically, various applications may add certain persona-specific parameters to the system's personas as required.

Capps et al. also discloses various techniques for changing the current persona adopted by the computer system. In accordance with one such technique, the user is allowed to select one of the personas listed on the display menu or list described above. Capps et al. notes that, in a pen-based computer system, this is preferably accomplished by determining when a user has tapped with a stylus on a displayed persona. In another technique disclosed in the reference, the current persona is determined by (1) identifying a password input by the user; (2) matching the password to one of the multiple personas available on the computer system; and (3) specifying the persona which is matched to the password in the previous step as the current persona.

### SUMMARY

In one embodiment, a method is provided for customizing a service to a user on a mobile technology platform equipped with a display and having multiple personas defined therein. The method comprises: determining which one of the multiple personas is the active persona; and customizing a service to the user based on the active persona.

In another embodiment, a method is provided for customizing a service to a user on a mobile technology platform. The method comprises: creating a first user profile based on the user's activities on the mobile technology platform while the user is in a first persona; creating a second user profile based on the user's activities on the mobile technology platform while the user is in a second persona; and customizing a service to the user, wherein the service is customized based on the first user profile when the user is in the first persona, and wherein the service is customized based on the second user profile when the user is in the second persona.

In a further embodiment, a method is provided for tagging the online behavior of a user on a mobile technology platform to the user's profile data. The method comprises: recording at least one parameter relating to the online behavior of a user of a mobile technology platform; determining the context in which the online behavior occurred; and using the context to tag the recorded parameter to the user's profile data. In some embodiments, a plurality of personas is associated with the user, and at least one of the plurality of personas (and, in some embodiments, exactly one persona) is active when the user is online, and at least one of the active personas reflects the determined context.

In another embodiment, a non-transient, tangible medium is provided which has suitable programming instructions recorded therein which, when executed, implement the foregoing systems and methodologies, in whole or in part.

### BRIEF DESCRIPTION OF THE DRAWINGS

FIG. 1 is an illustration of an embodiment of a system and methodology for gathering business intelligence.

FIG. 2 is an illustration of an embodiment of a system and methodology for choosing a means to reach a user based on persona tagging of collected data.

FIG. 3 is an illustration of an embodiment of a system and methodology for selecting a means to reach a user based on the active persona and the persona related to the acquisition of data.

FIG. 4 is an illustration of an embodiment of a system and methodology for inferring an active persona from various sources.

FIG. 5 is an illustration of an embodiment of a system and methodology for suggesting an active persona from a device with multi-persona capabilities.

FIG. 6 is an illustration of an embodiment of a system and methodology for tagging collected data.

FIG. 7 is an illustration of a base multi-persona system upon which some of the systems and methodologies disclosed herein may be implemented.

### DETAILED DESCRIPTION

As used herein, the term “persona” refers to a virtual environment which may comprise a set of user preferences associated with a user ID, and which govern the operation of an operating system. Multiple personas may be defined by a user in the systems and methodologies defined herein through the use of a suitable hardware virtualization technique such as a virtual machine manager (VMM) or “hypervisor”. A hypervisor may be utilized, for example, to allow multiple operating systems to run concurrently on a host device, where the hypervisor presents a virtual operating platform to the guest operating systems and manages execution of those operating systems.

There are two main types of hypervisors currently known to the art, namely, Type 1 (also known as “native” or “bare metal”) hypervisors, and Type 2 (also known as “hosted”) hypervisors. Type 1 hypervisors run directly on the host's hardware to control the hardware and to manage the guest operating systems. Hence, the guest operating systems run on another level above the hypervisor. Examples of Type 1 hypervisors include Citrix® XenServer, VMware® ESXi, and Microsoft® Hyper-V. Type 2 hypervisors run within a conventional operating system environment as a distinct second software level, with the guest operating systems running at a third level above the hardware. Examples of Type 2 hypervisors include KVM and Virtualbox. As used herein, the term “hypervisor” includes both Type 1 and Type 2 hypervisors.

While Capps et al. may be suitable for its intended purpose, further improvements are needed with respect to the implementation of multiple persona paradigms on mobile technology platforms. Some of these needs and improvements are addressed in commonly assigned a U.S. patent application Ser. No. 14/262,318 filed on Apr. 25, 2014 (hereinafter “Gonen et al.”), the contents of which are hereby incorporated by reference in their entirety. In Gonen et al., various systems and methodologies are described which relate to the user-experience on a phone having a user interface containing two or more personas that a user interacts with. Principles and mechanisms are disclosed which relate to four fundamental user-experience topics, namely, (a) awareness, (b) notifications, (c) switching, and (d) sharing. However, while these systems and methodologies represent a significant advance in the art, the focus there was on “explicit” user interaction with an operating system or device.

In particular, and not necessarily limited in this regard, the systems and methodologies that are disclosed in Gonen et al. are primarily focused on situations in which users are explicitly aware of the different personas, and where switching between those personas involves an explicit action on the part of the user. Likewise, in Gonen et al., sharing was also explicit in the sense that it required specific mechanisms (which might be somewhat ad-hoc) for each application or data type. Thus, for example, sharing was premised on one mechanism (or set of mechanisms) for phone settings, and another mechanism (or set of mechanisms) for alarm applications.

Some of these needs and improvements are also addressed in commonly assigned International Application No. PCT/IL2013/050153 filed on Feb. 20, 2013 (hereinafter “Laadan et al.”), entitled “Systems and Methods for Sharing and Switching Between Personas on Mobile Technology Platforms”, the contents of which are hereby incorporated by reference in their entirety. In particular, and not necessarily limited in this regard, systems and methodologies are disclosed in this application which leverages implicit interactions to reduce the awareness burden on users by automating the switch operation between personas depending on context and usage; and to generalize the underlying sharing mechanisms by making them more structured and transparent to applications.

However, there is a need in the art for further improvements in the use of personas, particularly as they relate to contexts (that is, the role in which a person operates). In particular, people assume different roles and, hence, operate in different contexts, in their online usage, as they do in life generally. Thus, for example, when people work, they are in a work context; when they speak with their spouse, they are in a personal context; when they speak with their children, they are in a parental context; and so on.

There is thus a need in the art for systems and methodologies (for mobile technology platforms in particular, but for other types of devices as well) which are context-sensitive, and which reflect any of the various “roles” that a user may be assuming at any particular time. For example, when a user is at work, interactions should occur via a work environment. When a user is with friends, various actions, such as sharing photos, should occur via a personal environment. These and other needs may be met by the systems, methodologies, and software disclosed herein.

It has now been found that the foregoing needs may be met through the use of systems, methodologies, and software disclosed herein in which the context in which a user is operating at a given moment during online usage is correlated to the user's profile. Hence, as users change from one context to another (either implicitly or explicitly); the new current context may be used to tag their profile data. This approach simplifies and improves the accuracy of the task of understanding online behavior and predicting intention from it, and therefore simplifies and improves the accuracy of the process of customizing services to the user. For example, this approach improves the ability of advertisers to more accurately gauge the intentions of an online consumer, thereby allowing them to present the user with advertisements which are more likely to be of interest to the user.

It has further been found that the foregoing needs may further be met, at least in part, by the appropriate use of prepackaged personas. For example, when users utilize prepackaged personas such as, for example, a gaming persona, their initial user profile (before any data collection occurs) will reflect this persona. Accordingly, the intention of the user may be simply and accurately understood from this prepackaged persona. Hence, this approach simplifies and improves the accuracy of the process of customizing services to the user. For example, this approach improves the ability of advertisers to more accurately gauge the intentions of an online consumer, thus allowing them to present the user with advertisements which are more likely to be of interest to the user.

The term “persona” is used hereinafter to indicate the technology representation of a person's “context” (as described above), that is, the environment that reflects the user's “role” at any particular moment. The systems and methodologies disclosed herein seek to build on a one-to-one mapping between a user's “context” and the user's “persona” (the technological realization of the user's behavior and intentions).

By way of comparison, in Laadan et al. and Gonen et al., the term “persona” was used to indicate a specific realization of this concept (e.g., through the use of virtualization, and in particular, lightweight virtualization). However, in the present context, the term also applies generally to other technological realizations of the concept of “context”. Such realizations may include, for example, the one described in Capps et al. Such realizations may also generally include “user profiles” (which generally differ from “personas” in that they only encapsulate some aspects of the environment, ranging from settings like wallpaper, ring tones, and screen-lock style, to settings that affect applications behavior (e.g. user profiles in a browser)). While “profiles” provide only partial (if any) separation between a user's contexts, they are still indicative of those contexts, and can thus provide indications of the behavior and intentions of the user.

The systems and methodologies disclosed herein leverage the ability to understand, at any time, the user's context, behavior, and intention, whether that occurs via personas, profiles, or other forms. By contrast, the existing solutions infer these properties from the observed behavior (for example, from the user's browsing habits via accounts or via cookies). However, this process is complicated and speculative, and is therefore inaccurate. Because “personas” are a one-to-one representation of “contexts”, they provide a much more precise indication of these properties, since they directly reflect the user's mode of operation. Thus, personas provide a simple and accurate means to obtain the user's context, behavior and intention.

In the following discussion, the systems and methodologies will frequently be described with reference to their implementation on mobile technology platforms. However, it will be appreciated that the concept of segmenting a user's life into contexts is a general concept which applies beyond the realm of mobile technology platforms. For example, this concept may be implemented on desktop PCs and other computerized devices as well.

Contexts may be utilized in the systems and methodologies described herein in a variety of ways. However, these uses may be generally divided into at least three categories that are of particular interest here. These include instances where (i) a context is known and used (for example, to collect data or push services); (ii) a context is inferred (for example, when a user doesn't have any personas); and (iii) a context is suggested (for example, the operating system or other software suggests a suitable persona or automatically changes personas). These situations are discussed in further detail below. In this discussion, the term “collected data” refers to data collected in connection with a persona.

In cases where a context is known, it may be used to collect accurate data about the user such as, data about the user's activities, for example, offline activities, online activities, past activities. This accuracy arises from the fact that contexts, when known, give a precise indication of the user's primary activity at any time, thus allowing for distinct behavioral profiles to be developed on a per activity basis.

The collected data may be used to offer, for example, services, advertisements, data, applications, and the like, to users. This may occur in a manner similar to that currently practiced in the art, except that information which is relevant to a particular context may be channeled through a means associated with that context. For example, email which is relevant to work may be channeled through a work email address or platform, while email which is relevant to personal or private matters may be routed through a private email address or platform. This may be accomplished through general channels (for example, through browser ads, emails, or text- messages), through any device (regardless of the device used to collect/tag the data), through any media (for example, even street ads could be personalized), and at any time. This may also be accomplished via channels correlated with the “context” such as, for example, through work-related ads via the work email. Such a correlation may be inferred from the aforementioned knowledge (for example, the email account was used in the work persona).

When a context is known, it may also be utilized to offer or select specific services, information, or advertisements to provide to users. The services, information, or advertisements may include, but are not limited to, tagged data which is based on past behavior. Because the “persona” is indicative of the user's current context, predictions on what may interest the user at any moment have the capability of being more focused and accurate. For example, indications of a current primary activity may be utilized for services and information relevant to that activity. By way of illustration, if a user is planning a lunch, a business or personal location may be suggested for the lunch based on the current context. Similarly, and by way of further illustration, when a user is searching for products to purchase, business grade or consumer grade products may be offered.

Collected data may also be utilized to automatically switch a user context. According to an embodiment, current data such as, for example, location, time, available networks, and voice recognition may be utilized to conclude that the user's behavior has been changed, and may be further utilized to suggest that the context be changed or to change the context automatically.

It is possible to infer the current user's context even when the device (mobile or not) does not reflect the current “context” (for example, if the device does not support “personas”). The inferred user's context can then be used as described above. One method to infer the user's context is through the use of sensors related to “physical” parameters such as location, available networks (e.g., Wi-Fi® or Bluetooth®), time, sound, voice, face recognition, and the like.

Another method is to infer the user's context using sensors related to “logical” parameters such as, for example, the user's activity, browsing habits, incoming/outgoing phone calls, and the like. Any of these “logical” parameters may be correlated with past behavior.

Still another method to infer the user's context is by looking at other devices that are owned or used by the same user. For example, the current context on a desktop that lacks support for personas may be inferred from the (same) user's mobile phone. Yet another method to infer the context is by looking at the context of colleagues or friends of the user (their context may be learned via their active persona, or may be inferred itself). The foregoing methods may be combined in various manners, combinations and sub-combinations.

By way of specific illustration, some mobile technology platforms lack multi-persona capabilities. For a user on such a platform, current data about friends and colleagues of the user may be utilized to infer the user's primary activity, thereby enhancing the user's profile. In some cases, data indicative of a behavioral change on the part of friends or colleagues of a user may be utilized to infer a similar behavioral change on the part of the user.

While the systems and methodologies described herein may be utilized to provide an active “persona” which faithfully reflects the current user's “context”, there are instances in which, when the user changes the context, there could be some lag until the “persona” changes as well (this “persona” change may occur explicitly by the user, or may occur implicitly as a result of such user's usage). In such cases, the mismatch between the current “context” and the active “persona” may be detected by using the techniques described above to continuously infer the user's current context and to compare against the current persona. Upon detecting a mismatch, a persona-switch may be suggested to the user. Such a persona switch may be suggested automatically, or may be proposed explicitly (for example, on a desktop with a pop-up, or on a mobile phone with a notification), or may be proposed implicitly by making the user-interface element used for switching more visible (thereby making the action of switching more apparent and simple).

Personas may also be inferred from aggregate context data (that is, from data from multiple users). For example, such aggregate context data may be utilized to gain knowledge on people and places, and for business intelligence. By way of illustration, if several colleagues enter a building in a work context, or switch to that context shortly thereafter, this information may be utilized, alone or in combination with other information, to infer that the building is a work location, or that a business meeting is occurring in the work location.

In some applications, personas may also be inferred by using context data from one device for other devices. Thus, for example, the current context on a mobile device may be utilized to offer services on other devices associated with the user, such as providing information, showing advertisements, or switching the context on other devices such as desktops or tablets (here it is to be noted that desktops are one example of a non-mobile platform that may also run multiple personas).

In some applications, current context data from other devices may be utilized to infer the context on a target device. Thus, for example, a context inferred from the user's activities on other devices, such as a desktop or laptop, may be utilized to understand the user's context on the target device.

It will be appreciated that aggregate context data may be manipulated to use devices and personas in new and different ways. By way of example, aggregate context data may be utilized to build social circles.

While contexts may be utilized in the systems and methodologies to obtain more or better data from users, the use of contexts as described herein may also be utilized to address the privacy concerns of users. At present, an increasing number of online sites collect substantial amounts of information about users. This may occur directly, as through the registration processes required by sites such as Facebook™ Gmail™, or ecommerce sites. It may also occur indirectly, as through the use of cookies and IP tracking.

Perhaps as a result of the foregoing, online users are increasingly conscious about their privacy. There is also a considerable push by many governments to more closely regulate what information is collected about users while they are online, and to ensure user privacy. In particular, there is growing interest in ensuring that some types of user information remains private, even while other information becomes more widely collected. Some of the systems and methodologies described herein may be utilized for this purpose.

In particular, with multiple personas, users may configure some personas to expose data (such as, for example, to connect to Facebook™ and keep browser cookies), while keeping other personas private. In fact, users may configure one persona for using Facebook™, another for LinkedIn®, another for Yahoo®, and so forth. By contrast, users can use one or more personas as their private zone. For example, the Facebook™ application may not be installed there, but instead, a Facebook™ shortcut may launch the application in the proper (other) persona. Additionally, users may configure some personas with a “no tracking” mark, analogous to the recent no-tracking initiative for browsers. In the future, other methods may be utilized to express preferences, such as, for example, privacy preferences, to service providers.

As additional examples of utilizing persona context to address privacy concerns, advertisers can offer benefits, such as online discounts, to users with permissive privacy settings so that they can learn about the users' shopping habits. Users concerned about their privacy in general can still take advantage of those benefits inside a “shopping” persona and shop with greater discounts for items for which they have no concerns about their privacy, such as buying a ticket to the cinema.

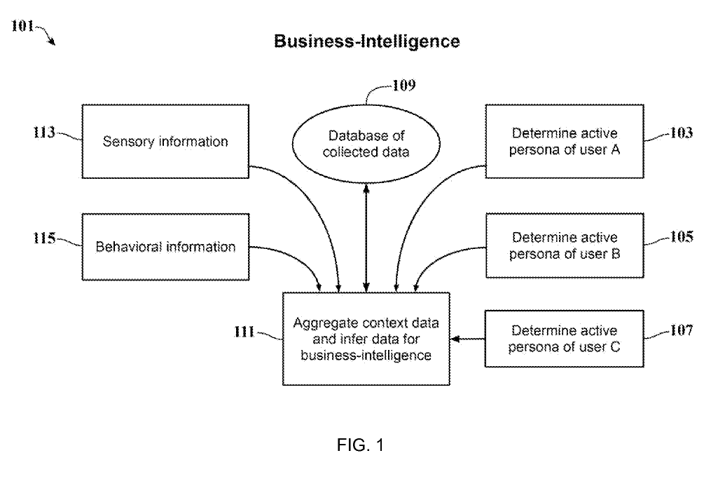

The foregoing systems and methodologies may be further understood with reference to the attached drawings. Thus, FIG. 1 illustrates a particular, non-limiting embodiment of a system and methodology for gathering business intelligence in accordance with the teachings herein. In the embodiment 101 depicted therein, the active persona of user A is determined 103, the active persona of user B is determined 105, and the active persona of user C is determined 107. Collected (tagged) data for these users is stored in a database 109. Then, context data from users A, B, and C is collected and examined 111, and data for business intelligence is inferred from the information in the database 109 and from the aggregate context data 111. The inferred data may be data of sensory information 113 such as, for example, locations and sites. The inferred data may also be data of behavioral information 115 such as, for example, about activities and other people. The inferred data may then be stored in the database 109 for further use.

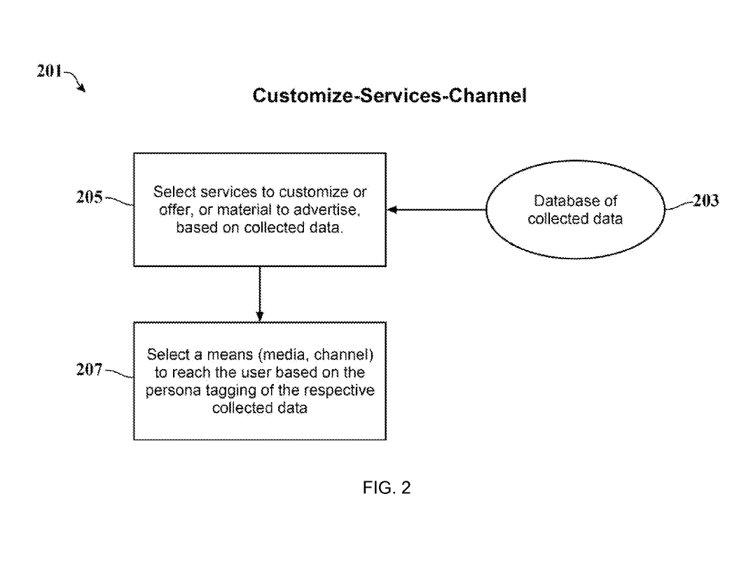

FIG. 2 illustrates a particular, non-limiting embodiment of a system and methodology for customizing a service channel. In the embodiment 201 depicted therein, a database 203 of collected data is maintained. Based on the collected data which is stored (and tagged) in the database 203, services or materials are selected 205 to offer, customize, or advertise. The persona tagging associated with the data used for this selection is then examined, and a means to reach the user is selected 207 based on the persona related to the acquisition of that data.

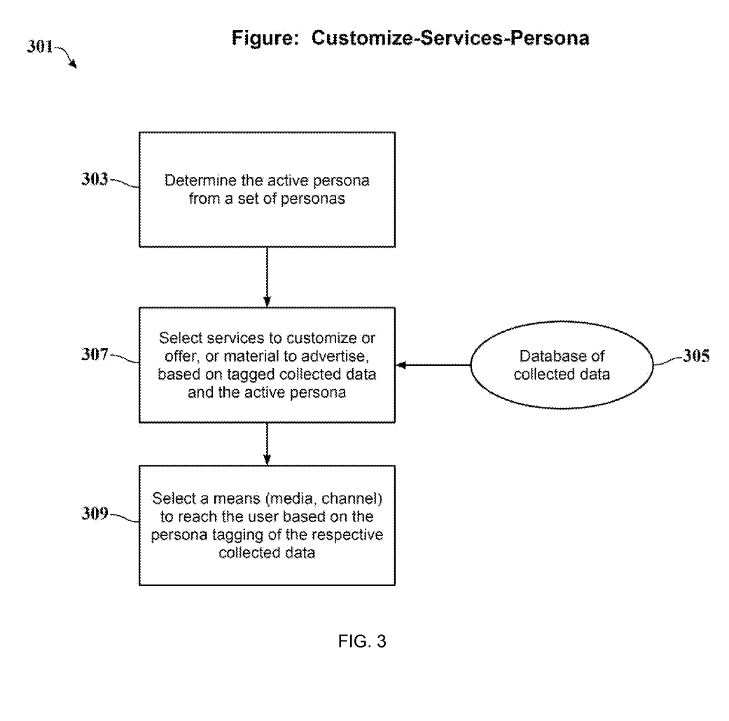

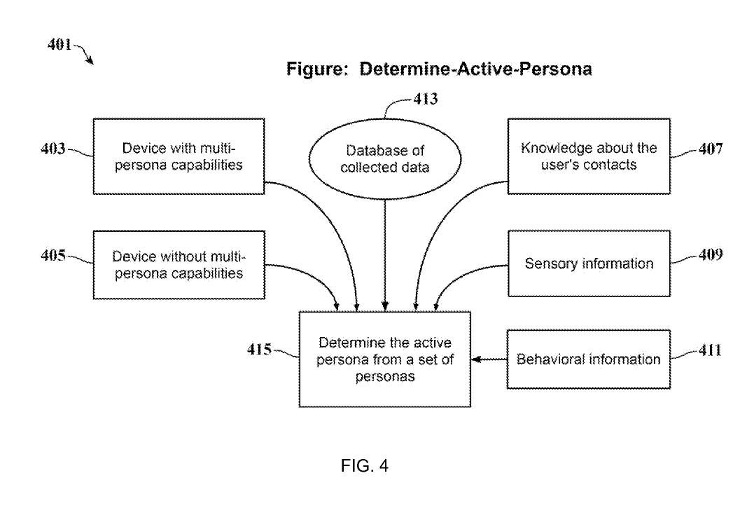

FIG. 3 illustrates a particular, non-limiting embodiment of a system and methodology for customizing services. In the embodiment 301 depicted therein, the active persona is determined 303 from a set of personas using the system and methodology depicted in FIG. 4. A database 305 of collected data is maintained. Based on the collected data stored (and tagged) in the database 305, and based on the active persona, services are selected 307 to offer to or customize for a user, or advertisements are selected 307 to be offered to the user. A means (such as, for example, a media or channel) is then selected 309 to reach the user, based on the active persona and the persona related to the acquisition of that data.

FIG. 4 illustrates a particular, non-limiting embodiment of a system and methodology for determining the active persona. The embodiment 401 depicted therein includes a first device 403 with multi-persona capabilities, and a second device 405 without multi-persona capabilities. When the user uses the first device 403, the device indicates the active persona. When the user uses the second device 405, the active persona may be inferred by correlation to another device (such as the first device 403) which is associated with the same user and which has multi-persona capabilities.

For example, knowledge about the active persona of a user's contacts 407 (such as, for example, friends, colleagues, or peers) may be utilized to infer a user's active persona. Similarly, sensory information 409 (such as, for example, location, time, or network signal) may be used to infer a user's active persona. Likewise, behavioral information 411 (such as, for example, emails and account used, services and websites visited, recent history or phone calls) may be utilized to infer the user's active persona. The foregoing information may be collected into a database 413 and may be utilized to determine the active persona from a set of personas 415.

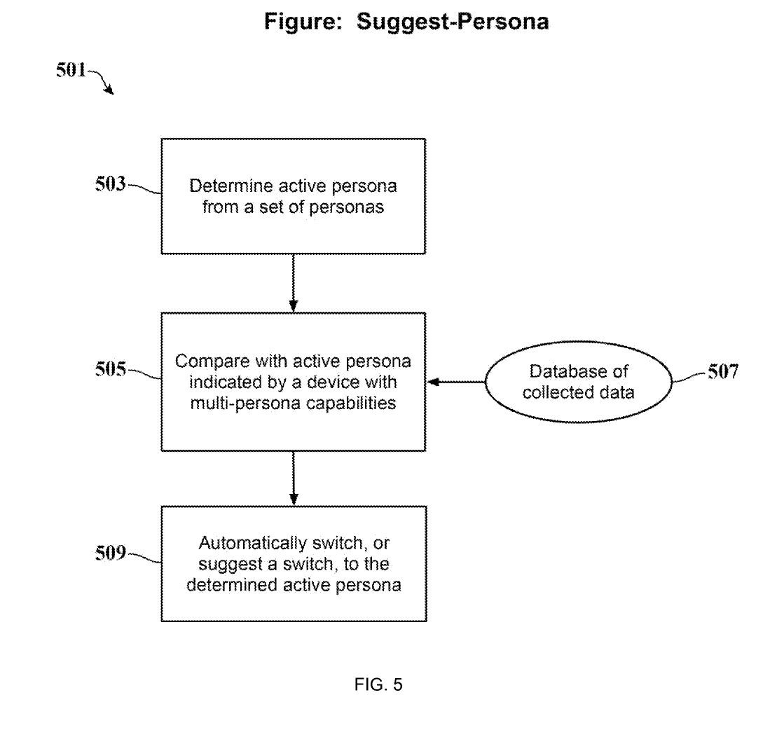

FIG. 5 illustrates a particular, non-limiting embodiment of a system and methodology for suggesting a persona. In the embodiment 501 depicted therein, an active persona is inferred 503 from a set of personas using the system and methodology of FIG. 4. The inferred persona is then compared 505 with the active persona reported by a device which is used by the user and which has multi-persona capabilities. A database 507 of collected data may be utilized for this purpose. If the active persona does not match the reported persona, a determination is made as to whether the mismatch is because the device does not reflect the active persona, or because a recent switch to another persona (by the user) has occurred. If it is concluded that the indication of the active persona by the device is outdated, then a switch 509 to the persona determined to be active is either suggested or is performed automatically.

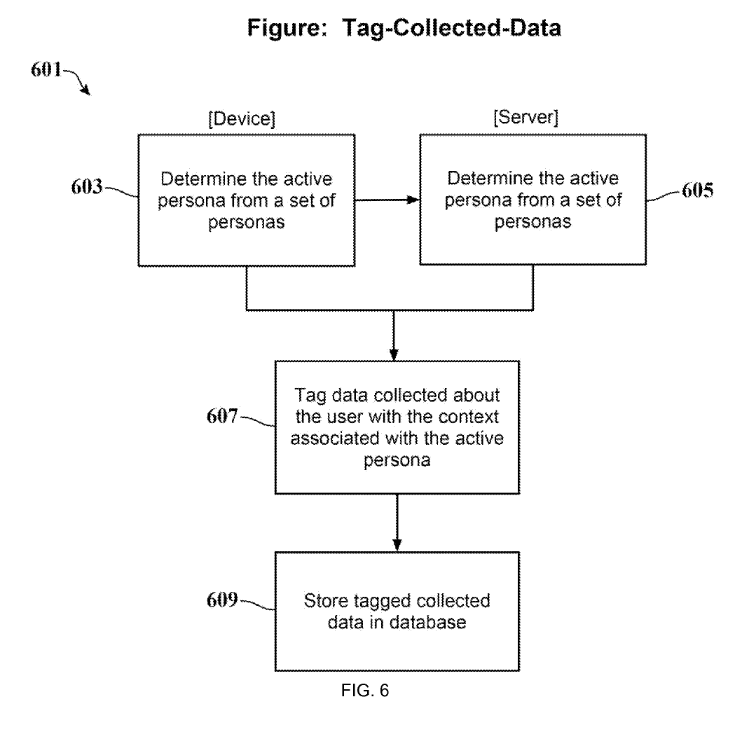

FIG. 6 illustrates a particular, non-limiting embodiment of a system and methodology for tagging collected data. In the embodiment 601 depicted therein, the active persona is determined from a set of personas, either on a device 603 used by the user, or on servers (services) 605 used by the user. The system and methodology of FIG. 4 may be used for this determination. Thus, for example, when a device with multi-persona capabilities communicates with servers (services) on behalf of the user, the device may indicate the active persona for those services. This may occur, for example, by using a special application programming interface (API) associated with the services, or through extensions (piggyback) on the communication protocol, such as hypertext transfer protocol (HTTP) or transmission control protocol (TCP).

The data collected about the user may originate from the devices or services that the user uses. The data is tagged 607 with the active persona to indicate the user context in which it was generated. The tagged collected data is stored 609 in a database, similar to other data collected.

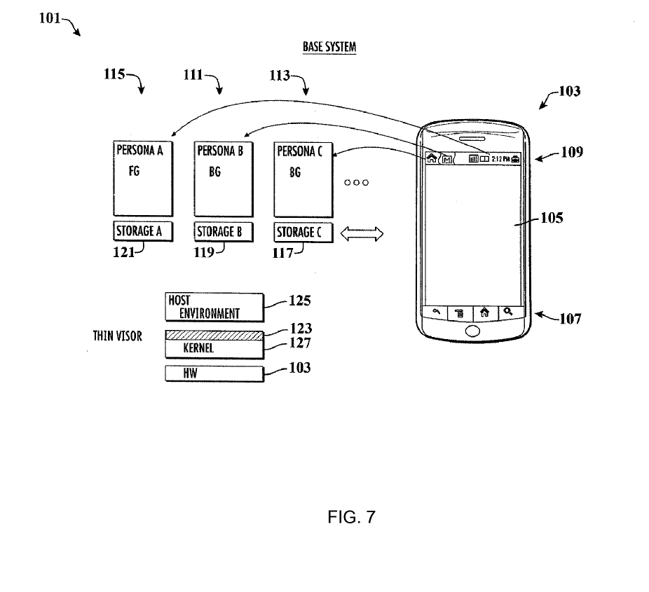

FIG. 7 is a particular, non-limiting embodiment of a base multi-persona system 701 upon which some of the systems and methodologies disclosed herein may be implemented. The base system is intended as a reference to a generic multi-persona system.

The right side of FIG. 7 depicts the general appearance of one particular, non-limiting embodiment of a mobile technology platform, which in the embodiment depicted is a mobile phone 703. The mobile phone 703 includes a display 705. A button region 707 with a plurality of buttons disposed therein is rendered on the bottom of the display 705, and a taskbar 709 is rendered at the top of the display 705.

The left-hand side of FIG. 7 provides a schematic overview of the multi-persona system 701. As seen therein, the taskbar 709 includes the background personas 711, 713 and the foreground persona 715, which have storage A 717, storage B 719 and storage C 721 associated therewith, respectively.

The system 701 includes hardware 703 (which is simply the device itself—in this embodiment, a mobile phone 703), a ThinVisor™ or hypervisor 723 and the host environment 725. The hypervisor 723 sits on top of a Linux or other kernel (the device's operating system) 727. The host environment 725 serves as the place where the control logic of the ThinVisor™ or hypervisor 723 is running, and functions as a hardware persona for some services, and as a software persona for other services.

Each persona may also run a Service process (not depicted) that is responsible for communicating with the main Control (also not depicted) that runs in the host environment. The Control is responsible for proxying and routing messages between personas, and for switching the foreground persona. It is to be understood that, as used in the present context, the term, “process” refers to an instance of a computer program that is executed by a processor.

Several modifications and variations are possible with respect to the systems and methodologies described above. For example, while these systems and methodologies have frequently been described with respect to their implementation on mobile communications devices, one skilled in the art will appreciate that these systems and methodologies may also be implemented on various other mobile technology platforms including, but not limited to, book readers (such as Amazon's Kindle® book reader), displays, and various types of mobile computers.

Moreover, one skilled in the art will appreciate that the various systems and methodologies disclosed herein may include, incorporate, or be implemented by suitable software. Such software may be disposed or recorded in a non-transient, tangible medium and may contain suitable programming instructions which, when executed, implement the foregoing systems and methodologies, in whole or in part.

The above description of the present invention is illustrative, and is not intended to be limiting. It will thus be appreciated that various additions, substitutions and modifications may be made to the above described embodiments without departing from the scope of the present invention. Accordingly, the scope of the present embodiments should be construed in reference to the appended claims.

What is claimed is:

1. A method for customizing a service to a user on a mobile technology platform, comprising:
determining which of a plurality of personas defined in the mobile technology platform is an active persona, wherein each persona of the plurality of personas is defined as a set of user preferences associated with an operating system of the mobile technology platform; and
customizing a service to the user based on the active persona.

2. The method of claim 1, wherein customizing the service to the user includes at least one of: targeting an advertisement to the user; targeting a content item to the user;
pushing data to the user; and sharing data.

3. The method of claim 2, wherein customizing the service to the user further includes using the active persona to determine at least one of: demographic information about the user, a gender of the user, a socioeconomic status of the user, a profession of the user, one or more hobbies of the user, and whether the user is using the mobile technology platform for a first type of use or for a second type of use.

4. The method of claim 3, wherein the first type of use includes a business use and the second type of use includes a personal use.

5. The method of claim 2, further comprising:
sorting each of a group of services into a first set of services that are primarily targeted towards one or more users who are using the mobile technology platform for the first type of use, and a second set of services that are primarily targeted towards one or more users who are using the mobile technology platform for the second type of use; and
determining whether the active persona corresponds to the first type of use or to the second type of use of the mobile technology platform.

6. The method of claim 5, further comprising:
generating a service from the first set of services, when the active persona is determined to correspond to the first type of use; and
generating a service from the second set of services, when the active persona is determined to correspond to the second type of use.

7. The method of claim 6, further comprising:
determining a delivery channel for the generated service respective of the service type, wherein the delivery channel is at least one of: the mobile technology platform and another device associated with the user.

8. The method of claim 7, wherein the service is delivered in a form of at least one of: a banner advertisement; a pop-up advertisement; a pop-up message; a short message service (SMS); a multimedia message service (MMS); a component of the operating system of the mobile technology platform; a browser; an application, and an email.

9. The method of claim 2, wherein targeting the service to the user occurs during a browsing session.

10. The method of claim 9, wherein the active persona is a persona that is found in the foreground at the time the service is targeted to the user.

11. The method of claim 1, wherein at least one persona of the plurality of personas is active at any time.

12. The method of claim 1, wherein each of the plurality of personas has a data store associated with it, and wherein customizing the service to the user further comprises selecting at least one option for the service based on the contents of the data store.

13. The method of claim 1, wherein customizing the service to the user is further based on at least one of: a comparison of the active persona to the remaining personas defined for the user, and activities undertaken by the user while in the active persona.

14. The method of claim 13, wherein the activities undertaken by the user while in the active persona include at least one of: past activities; offline activities; and online activities.

15. The method of claim 1, wherein customizing the service to the user when the user is in a particular persona is conditional on a variable which is associated with the persona and whose value may be set by the user.

16. The method of claim 15, wherein the variable is changed between a first value which enables customizing a service to the user based on the given persona when the given persona is active, and a second value which disables customizing a service to the user based on the given persona when the given persona is active.

17. The method of claim 1, wherein customizing the service to the user based on the active persona further comprises:
collecting data about the user; and
using the collected data to determine a user current context.

18. The method of claim 17, wherein the user current context is associated with a persona associated with the user which was active when the data was collected.

19. The method of claim 17, wherein collecting the data about the user occurs on at least one of the mobile technology platform, and any device owned or used by the user.

20. A communication terminal, comprising:
a user interface;
a processing unit; and
a memory, the memory containing instructions that, when executed by the processing unit, configure the terminal to:
determine which of a plurality of personas defined in the mobile technology platform is an active persona, wherein each persona of the plurality of personas is defined as a set of user preferences associated with an operating system of the mobile technology platform; and
customize a service to the user based on the active persona.

21. The communication terminal of claim 20, wherein the terminal is further configured to: target an advertisement to the user; push data to the user; target a content item to the user; and share data.

22. The communication terminal of claim 21, wherein the terminal is further configured to use the active persona to determine at least one of: demographic information about the user, a gender of the user, a socioeconomic status of the user, a profession of the user, one or more hobbies of the user, and whether the user is using the mobile technology platform for a first type of use or for a second type of use.

23. The communication terminal of claim 22, wherein the first type of use includes a business use and the second type of use includes a personal use.

24. The communication terminal of claim 20, wherein the terminal is further configured to:
sort each of a group of services into a first set of services that are primarily targeted towards one or more users who are using the mobile technology platform for the first type of use, and a second set of services that are primarily targeted towards one or more users who are using the mobile technology platform for the second type of use; and
determine whether the active persona corresponds to the first type of use or to the second type of use of the mobile technology platform.

25. The communication terminal of claim 24, wherein the terminal is further configured to:
generate a service from the first set of services, when the active persona is determined to correspond to the first type of use; and
generate a service from the second set of services, when the active persona is determined to correspond to the second type of use.

26. The communication terminal of claim 25, wherein the terminal is further configured to:
determine a delivery channel for the generated service respective of the service type, wherein the delivery channel is at least one of: the mobile technology platform and another device associated with the user.

27. The communication terminal of claim 26, wherein the service is delivered in a form of at least one of: a banner advertisement; a pop-up advertisement; a pop-up message; a short message service (SMS); a multimedia message service (MMS); a component of the operating system of the mobile technology platform; a browser; an application; and an email.

28. The communication terminal of claim 20, wherein the customization of the service to the user is further based on at least one of: a comparison of the active persona to the remaining personas defined for the user, and activities undertaken by the user while in the active persona.

29. The communication terminal of claim 29, wherein activities undertaken by the user while in the active persona include at least one of: past activities; offline activities;
and online activities.

30. The communication terminal of claim 20, wherein the system is further configured to:
collect data about the user; and
use the collected data to determine a user current context.

31. The communication terminal of claim 30, wherein the user current context is associated with a persona associated with the user which was active when the data was collected.

32. A non-transitory computer readable medium having stored thereon instructions for causing one or more processing units to execute the method according to claim 20.

33. A method for tagging activities of a user of a mobile technology platform, comprising:
recording at least one parameter relating to the activities of the user;
determining a user current context in which the activities occurred; and
using the user current context to tag the at least one recorded parameter to at least one persona of plurality of personas, wherein each of the plurality of personas is defined as a set of user preferences associated with an operating system of the mobile technology platform.

34. The method of claim 33, wherein the user current context is associated with a persona associated with the user which was active when the data was collected.
